(19) United States
(12) Patent Application Publication
(10) Pub. No.: US 2025/0224081 A1
(43) Pub. Date: Jul. 10, 2025

(54) SENSOR OUTPUT CONFIRMATION IN HYDROCARBON STORAGE ENVIRONMENTS

(71) Applicant: Clean Connect AI, Inc, Windsor, CO (US)

(72) Inventors: Mehdi Korjani, Pasadena, CA (US); David A. Conley, Windsor, CO (US); Mark H. Smith, Gilbert, AZ (US)

(21) Appl. No.: 19/012,035

(22) Filed: Jan. 7, 2025

Related U.S. Application Data
(60) Provisional application No. 63/618,677, filed on Jan. 8, 2024.

(51) Int. Cl. F17C 13/02; G01D 18/00

(52) U.S. Cl. CPC F17C 13/02; G01D 18/00; F17C 2260/038; G01D 2218/10

(57) ABSTRACT

Various embodiments of the present technology relate to solutions for leak detection in hydrocarbon storage environments. In some examples, a leak identification system confirms sensor outputs in a hydrocarbon storage environment. The leak identification system comprises processing circuitry. The processing circuitry obtains sensor data that characterizes hydrocarbon inputs and hydrocarbon outputs in the hydrocarbon storage environment. The processing circuitry processes the sensor data using a thermodynamic model to determine when a discrepancy exists between the hydrocarbon inputs and the hydrocarbon outputs. The processing circuitry generates feature vectors that represent video data that depicts the hydrocarbon storage environment. The processing circuitry provides the feature vectors as input to a machine learning engine trained to detect hydrocarbon leaks in the hydrocarbon storage environment. The processing circuitry receives a machine learning output that indicates when a hydrocarbon leak exists in the hydrocarbon storage environment.

### CROSS-REFERENCE TO RELATED APPLICATIONS

This U.S. Patent Application claims the benefit of and priority to U.S. Provisional Patent Application 63/618,677 titled “SENSOR OUTPUT CONFIRMATION IN HYDROCARBON STORAGE ENVIRONMENTS” which was filed on Jan. 8, 2024. U.S. Provisional Patent Application 63/618,677 is incorporated into this U.S. Patent Application in its entirety.

### TECHNICAL FIELD

Various embodiments of the present technology relate to hydrocarbon extraction technologies, and more specifically, to detecting and confirming sensor readings using machine learning systems.

### BACKGROUND

Hydrocarbon extraction systems comprise machinery and equipment configured to extract petroleum, natural gas, and other types of chemicals for use in energy generation, heating, and chemical production applications. Hydrocarbon extraction systems comprise extraction equipment, transfer equipment, and storage equipment. The extraction equipment removes hydrocarbons from subterranean reservoirs. Examples of extraction equipment include drilling rigs and hydraulic fracturing devices. The transfer equipment transports the extracted hydrocarbons between different geographic locations. Examples of transfer equipment include pipelines and tanker trucks. The storage equipment stores the extracted hydrocarbons. Examples of storage equipment include bullet tanks and storage vessels. Operators often need to survey the hydrocarbons extraction equipment, storage equipment, and transfer equipment to ensure the equipment is operating properly.

Conventional methods to monitor hydrocarbon extraction, storage, and transfer equipment use surveillance cameras and on-site human operators to track the status of the equipment. The surveillance cameras are mounted at elevation and positioned to view the equipment of interest. The cameras generate video depicting the equipment and transfer the video to a centralized monitoring station. There, human operators review the video footage to identify the status of the equipment. The hydrocarbon storage equipment can develop leaks that harm the environment. Sensors that monitor the input and output of hydrocarbons in the storage equipment can malfunction causing the leaks to go undetected.

Unfortunately, conventional surveillance systems do not efficiently monitor hydrocarbon equipment. Moreover, these surveillance systems do not effectively detect sensor malfunctions in hydrocarbon equipment.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for leak detection systems in hydrocarbon extraction and storage environments. Some embodiments comprise a method of operating a leak detection system to confirm sensor outputs in a hydrocarbon storage environment. The method comprises obtaining sensor data that characterizes hydrocarbon inputs and hydrocarbon outputs in the hydrocarbon storage environment. The method further comprises processing the sensor data using a thermodynamic model to determine when a discrepancy exists between the hydrocarbon inputs and the hydrocarbon outputs. The method further comprises generating feature vectors that represent video data that depicts the hydrocarbon storage environment. The method further comprises providing the feature vectors as input to a machine learning engine trained to detect hydrocarbon leaks in the hydrocarbon storage environment. The method further comprises receiving a machine learning output that indicates when a hydrocarbon leak exists in the hydrocarbon storage environment.

Some embodiments comprise a leak detection system to confirm sensor outputs in a hydrocarbon storage environment. The leak detections system comprises processing circuitry. The processing circuitry obtains sensor data that characterizes hydrocarbon inputs and hydrocarbon outputs in the hydrocarbon storage environment. The processing circuitry processes the sensor data using a thermodynamic model to determine when a discrepancy exists between the hydrocarbon inputs and the hydrocarbon outputs. The processing circuitry generates feature vectors that represent video data that depicts the hydrocarbon storage environment. The processing circuitry provides the feature vectors as input to a machine learning engine trained to detect hydrocarbon leaks in the hydrocarbon storage environment. The processing circuitry receives a machine learning output that indicates when a hydrocarbon leak exists in the hydrocarbon storage environment.

Some embodiments comprise a non-transitory computer-readable medium stored thereon instructions to confirm sensor outputs in a hydrocarbon storage environment. The instructions, in response to execution, cause a system comprising a processor to perform operations. The operations comprise obtaining sensor data that characterizes hydrocarbon inputs and hydrocarbon outputs in the hydrocarbon storage environment. The operations further comprise processing the sensor data using a thermodynamic model to determine when a discrepancy exists between the hydrocarbon inputs and the hydrocarbon outputs. The operations further comprise generating feature vectors that represent video data that depicts the hydrocarbon storage environment. The operations further comprise providing the feature vectors as input to a machine learning engine trained to detect hydrocarbon leaks in the hydrocarbon storage environment. The operations further comprise receiving a machine learning output that indicates when a hydrocarbon leak exists in the hydrocarbon storage environment.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary hydrocarbon storage environment.

FIG. 2 illustrates an exemplary sensor confirmation process.

FIG. 3 illustrates an exemplary sensor confirmation process.

FIG. 4 illustrates an exemplary machine learning model.

FIG. 5 illustrates an exemplary thermodynamic model.

FIG. 6 illustrates an exemplary compute engine.

FIG. 7 illustrates an exemplary natural gas storage environment.

FIG. 8 illustrates an exemplary detection system.

FIG. 9 illustrates an exemplary user computer.

FIG. 10 illustrates an exemplary user interface.

FIG. 11 illustrates an exemplary distributed ledger system.

FIG. 12 illustrates an exemplary computing system.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

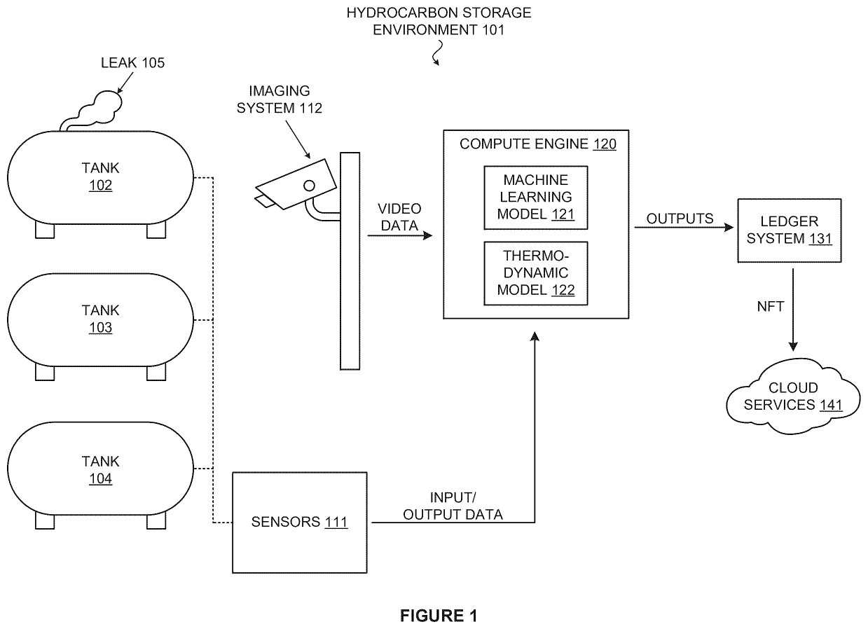

FIG. 1 comprises view 100. View 100 illustrates hydrocarbon storage environment 101 to confirm sensor outputs. Environment 101 performs services like hydrocarbon storage, hydrocarbon transfer, hydrocarbon extraction, hydrocarbon leak detection, and hydrocarbon leak notification. Environment 101 comprises storage tanks 102-104, sensors 111, leak 105, imaging system 112, compute engine 120, machine learning model 121, thermodynamic model 122, ledger system 131, and cloud services 141. In other examples, environment 101 may include fewer or additional components than those illustrated in FIG. 1. Likewise, the illustrated components of environment 101 may include fewer or additional components, assets, or connections than shown. Sensors 111, imaging system 112, compute engine 120, ledger system 131, and cloud services 141 may each be representative of a single computing apparatus or multiple computing apparatuses.

Various examples of system operation and configuration are presented herein. In some examples, compute engine 120 is representative of a leak identification system and comprises processing circuitry. Compute engine 120 obtains sensor data from sensors 111 that characterizes hydrocarbon inputs and hydrocarbon outputs in environment 101. Compute engine 120 processes the sensor data using thermodynamic model 122 to determine when a discrepancy exists between the hydrocarbon inputs and the hydrocarbon outputs. Compute engine 122 generates feature vectors that represent video data generated by imaging system 112 that depicts the environment 101. Compute engine 120 provides the feature vectors as input to machine learning model 121. Model 121 is trained to detect hydrocarbon leaks in environment 101. Compute engine 120 receives a machine learning output that indicates when a hydrocarbon leak (e.g., leak 105) exists in environment 101. When the hydrocarbon leak does not exist and when the discrepancy between the hydrocarbon inputs and the hydrocarbon outputs does not exist, compute engine 120 interfaces with ledger system 131 to generate a non-fungible token verifying that the hydrocarbon leak does not exist. Ledger system 131 may then provide the non-fungible token to cloud service 141. When the hydrocarbon leak exists, compute engine 120 generates data for rendering a user interface to depict the hydrocarbon leak and equipment associated with the hydrocarbon leak and transfers the data to a user system. When the hydrocarbon leak does not exist and when the discrepancy between the hydrocarbon inputs and the hydrocarbon outputs exists, compute engine 120 classifies the discrepancy as a sensor malfunction and transfers a notification indicating the one or more malfunctioning sensors. For example, compute engine 120 may transfer the notification for delivery to on-site operators (e.g., via text message) to resolve the sensor error.

Advantageously, compute engine 120 and imaging system 112 efficiently monitors tanks 102-104. Moreover, compute engine 120 effectively detects malfunctions in sensors 111. In doing so, compute engine 120 may certify that it is leak free or emitting gaseous hydrocarbons below a threshold.

Storage tanks 102-104 are representative of hydrocarbon storage equipment. Exemplary storage equipment includes bullet tanks, oil tanks, Liquified Natural Gas (LNG) storage tanks, gasholders, storage vehicles, and/or other types of storage systems. In some examples, environment 101 may comprise additional devices for hydrocarbon extraction and hydrocarbon transfer. For example, environment 101 may comprise hydraulic fracturing equipment, natural gas pipeline equipment, gas storage and transfer vehicles, and the like.

Sensors 111 are representative of telemetry devices configured to measure and report storage metrics like tank inputs, tank outputs, tank temperature, tank pressure, vent status, tank volume, tank location, tank type, and/or other types of data characterizing the status of tanks 102-104. Exemplary telemetry devices include thermometers, pressure gauges, flowmeters, on/off indicators, Global Positioning System (GPS) devices, and the like. Sensors 111 are operatively coupled to tanks 102-104. Sensors 111 interact with tanks 102-104 to generate telemetry data and report the telemetry data to compute engine 120. Sensors 111 may also include environmental sensors and may provide environmental telemetry like temperature, pressure, wind speed, wind direction, clouds, visibility, humidity, dew point, and the like. The environmental telemetry metrics improve machine learning model performance (e.g., performance of model 121) and help the machine learning model better understand the condition of environments when the gas is leaking.

Leak 105 is representative of a fuel leak from storage tank 102. For example, leak 105 may comprise a gaseous hydrocarbon (e.g., methane, natural gas, volatile organic compounds, etc.) outflow from tank 102. In some examples, leak 105 is the result of defect in tank 102 allowing the fuel contained within tank 102 to leak out. The defect may comprise a crack, faulty valve, or some other type of defect that compromises the storage ability of tank. In some examples, leak 105 is the result of intentional venting from tank 102. For example, tank 102 may receive an excess of natural gas and the excess gas may be flared from tank 102 to inhibit excessive pressure in tank 102.

Imaging system 112 is representative of one or more imaging systems to view tanks 102-104 and generate videos depicting tanks 102-104. In this example, imaging system 112 generates infrared and/or optical video images depicting tanks 102-104, however in other examples, imaging system 112 may employ a different type of imaging technology. For example, imaging system 112 may instead comprise an ultraviolet imaging system. It should be understood that gaseous hydrocarbon leaks are difficult to view in the visual light spectrum. As such, imaging system 112 typically comprises imaging technology for generating images in non-visible spectrums (e.g., infrared). Although imaging system 112 is illustrated as a single imaging device, in some examples imaging system 112 may comprise multiple imaging devices. The multiple cameras of imaging system 112 may include a combination of visible spectrum, infrared, ultraviolet, and/or laser cameras and imaging devices to improve the gas leak detection. Imaging system 112 may also include distance metric devices like laser rangefinders to estimate the distance between leak 105 and imaging system 112 to improve leak estimation. Imaging system 112 transfers the videos depicting tanks 102-104 to compute engine 120. Imaging system 112 is mounted on camera mount 122. Although imaging system 112 is depicted as mounted as on pole, imaging system 112 may comprise a different type of mounting structure or imaging system 112 may use no mounting structure at all. Imaging system 112 may include a pan and tilt system that moves the camera in multiple directions and orientations to cover a wider range and stabilize the field of view. Imaging system 112 may include a gimbal to stabilize imaging system 105. Imaging system 112 may comprise a controller to move imaging system 112 to pre-defined views and control the direction of imaging system 112 to provide a 360-degree field of view with imaging system 112. The controller of imaging system 112 may receive instructions (e.g., from compute engine 120) and responsively position imaging system 112 to find leak 105 and stay on view of leak 105.

Compute engine 120 is representative of one or more computing devices configured to receive video data from imaging system 112 and telemetry data from sensors 111 to identify the presence of leak 105 and confirm sensor outputs from sensors 111. The one or more computing devices of compute engine 120 host machine learning model 121 and thermodynamic model 122. For example, compute engine 120 may comprise an application specific circuit configured to implement a machine learning model and a thermodynamic model. Compute engine 120 may additionally host interfacing applications to receive and preprocess the video and telemetry data from imaging system 112 and sensors 111. The interfacing applications may vectorize the received data to configure the data for ingestion by model 121. For example, vectorization may comprise a feature extraction process to numerically represent the received data. In some examples, compute engine 120 may generate feature vectors that represent individual pixels of the video data received from imaging system 112. Compute engine 120 may be located on site (e.g., with sensors 111 and imaging system 112), may be located at remote location, or may be distributed between the extraction site and the remote location. For example, compute engine 120 may be integrated into imaging system 112.

Machine learning model 121 comprises any machine learning model implemented within environment 101 as described herein to detect the presence of gas leaks. A machine learning model comprises one or more machine learning algorithms that are trained based on historical data and/or other types of training data. A machine learning model may employ one or more machine learning algorithms through which data can be analyzed to identify patterns, make decisions, make predictions, or similarly produce output that can identify the presence of gas leaks in environment 101. Model 121 may comprise algorithms to detect background environments, to detect motion, to detect equipment, to classify gas leaks, and/or other types of machine learning algorithms. Examples of machine learning algorithms that may be employed solely or in conjunction with one another include Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data. Machine learning model 121 may be deployed on premises in environment 101 (e.g., proximate to tanks 102-104) or at a remote location in the cloud.

Machine learning model 121 may be trained to detect gas leaks using videos generated by imaging system 112. For example, imaging system 112 may transfer the training video images to user computer 141. A user may then annotate image frames of the video to create a training data set. The user may also combine environment and equipment information in the training data set. The annotations classify or segment portions of the images. For example, the annotations may classify a portion of the images as storage tanks 102-104, another portion of the images as a gas leak, and another portion of the images as background environment. User computer 141 transfers the training data to compute engine 120 to train model 121. Compute engine 120 receives and vectorizes the training data. Model 121 ingests the training data and trains its constituent machine learning algorithms to detect leak 105 using the training data.

Thermodynamic model 122 comprises any model implemented within environment 101 as described herein to track mass/volumetric hydrocarbon inputs/outputs in environment 101. Thermodynamic model 122 comprises one or more algorithms to balance hydrocarbon inputs and outputs in environment 101. For example, thermodynamic model 122 may track mass/volume inputs, stored reserves, and mass/volume outputs in tanks 102-104 to determine if any discrepancies exist. In examples where leak 105 is caused by a defect in tank 102, the input mass/volume and the output mass/volume reported by sensors 111 may not align. Thermodynamic model 122 may provide the inputs, outputs, stored reserves, and stored capacity into its algorithms to determine if a discrepancy exists. The algorithms may take additional inputs like compressibility, density, molar mass, temperature, pressure, and/or other physical attributes to detect input/output discrepancies. The outputs from models 121 and 122 may be combined to determine when environment 101 is leak free, the detected leaks are below a tolerance threshold, and a malfunction or calibration error exists in sensors 111. For example, when machine learning model 121 determines the flowrate of leak 105 is below a tolerance threshold and thermodynamic model 122 determines a discrepancy exists between the input and output readings of sensors 111, compute engine 120 may determine one or more of sensors 111 is malfunctioning. For example, when machine learning model 121 determines the flowrate of leak 105 is below a tolerance threshold and thermodynamic model 122 determines that there is no discrepancy between the input and output readings of sensors 111, compute engine 120 may interface with ledger system 131 to mint a non-fungible token certifying environment 101 is clean (e.g., abiding by Environmental Protection Agency (EPA) regulations).

Ledger system 131 is representative of a distributed ledger to mint non-fungible tokens (NFTs) confirming when environment 101 is leak free, or when the leaks in environment 101 are below a threshold. Ledger system 131 comprises a set of distributed ledger nodes that store a copy of a blockchain. The blockchain comprises data blocks that store data indicating environment 101 is leak free, or when the leaks in environment 101 are below a threshold (e.g., when storage tanks 102-104 are operating cleanly). The ledger nodes add additional blocks to the blockchain when the nodes reach a consensus. Ledger system 131 may receive outputs from compute engine that indicate environment 101 is clean (i.e., environment 101 is leak free or the leaks in environment 101 are below a tolerance threshold). Ledger system 131 distributes the output amongst the blockchain nodes. When the nodes reach a consensus that the output is valid, the nodes commit the output to the blockchain and mint a non-fungible token that points to this the newly committed block. Ledger system 131 transfers the non-fungible token to cloud service 141 where it can be sold on the market.

Sensors 111, imaging system 112, compute engine 120, ledger system 131, and cloud services 141 communicate over various communication links using communication technologies like Institute of Electrical and Electronic Engineers (IEEE) 802.3 (ENET), IEEE 802.11 (WIFI), Bluetooth, Time Division Multiplex (TDM), Data Over Cable System Interface Specification (DOCSIS), Internet Protocol (IP), General Packet Radio Service Transfer Protocol (GTP), and/or some other type of wireline and/or wireless networking protocol. The communication links comprise metallic links, glass fibers, radio channels, or some other communication media. The links use ENET, WIFI, virtual switching, inter-processor communication, bus interfaces, and/or some other data communication protocols.

Sensors 111, imaging system 112, compute engine 120, ledger system 131, and cloud services 141 comprise microprocessors, software, memories, transceivers, bus circuitry, and the like. The microprocessors comprise Central Processing Units (CPUs), Graphical Processing Units (GPUs), Digital Signal Processors (DSPs), Application-Specific Integrated Circuits (ASICs), Field Programmable Gate Arrays (FPGAs), analog computing circuits, and/or the like. The memories comprise Random Access Memory (RAM), flash circuitry, Hard Disk Drives (HDDs), Solid State Drives (SSDs), Non-Volatile Memory Express (NVMe) SSDs, and/or the like. The memories store software like operating systems, user applications, networking applications, machine learning applications, and the like. The microprocessors retrieve the software from the memories and execute the software to drive the operation of environment 101 as described herein.

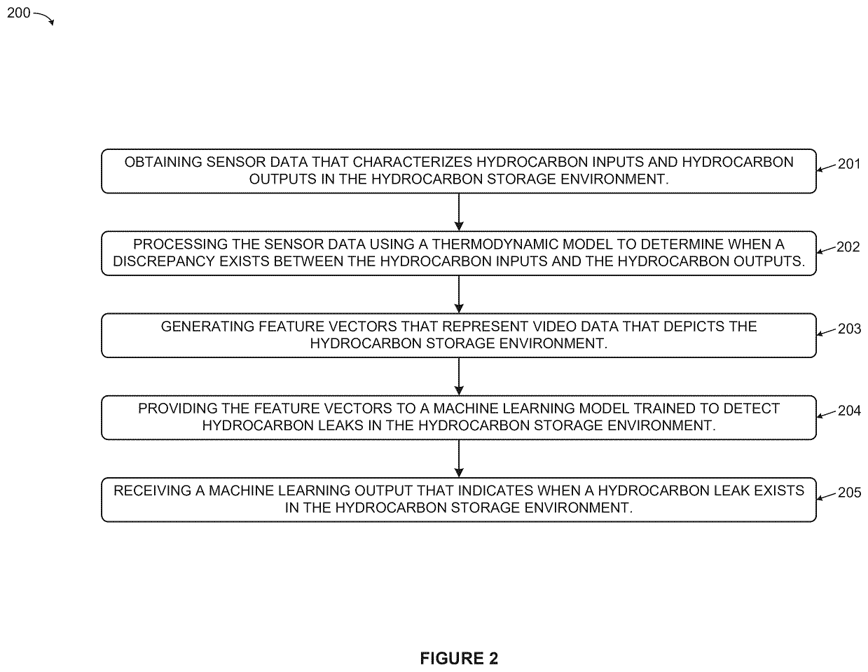

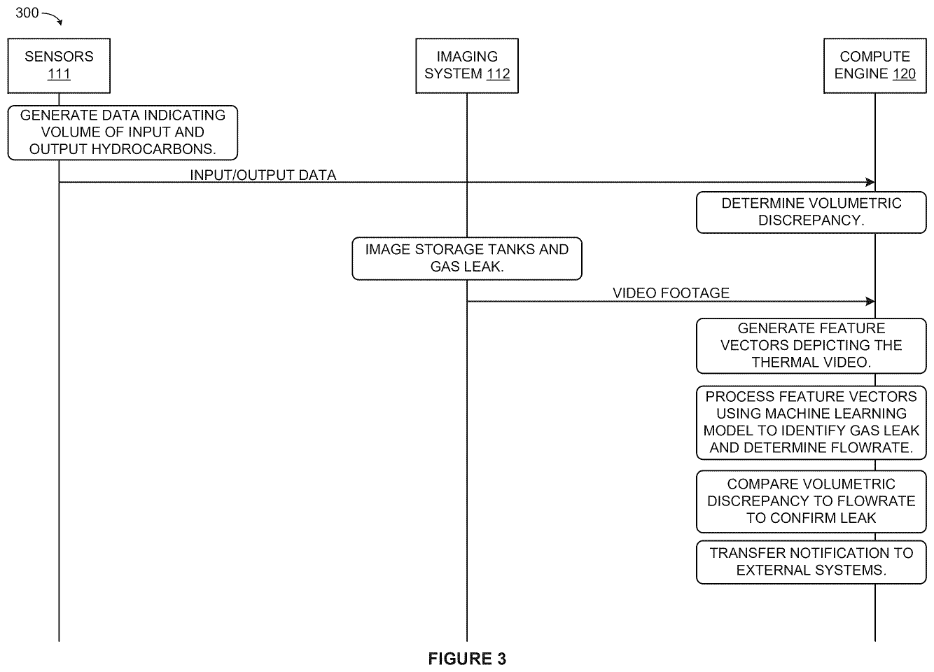

In some examples, environment 101 implements process 200 illustrated in FIG. 2. In some examples, environment 101 implements process 300 illustrated in FIG. 3. It should be appreciated that the structure and operation of environment 101 may differ in other examples.

FIG. 2 illustrates process 200. Process 200 comprises sensor confirmation process in hydrocarbon extraction and storage environment. In other examples, process 200 may differ. Process 200 may be implemented in program instructions in the context of any of the software applications, imaging components, module components, machine learning components, or other such elements of one or more computing devices. The program instructions direct the computing device(s) to operate as follows, referred to in the singular for the sake of clarity.

The operations of process 200 comprise obtaining sensor data that characterizes hydrocarbon inputs and hydrocarbon outputs in the hydrocarbon storage environment (step 201). The operations further comprise processing the sensor data using a thermodynamic model to determine when a discrepancy exists between the hydrocarbon inputs and the hydrocarbon outputs (step 202). The operations further comprise generation feature vectors that represent video data that depicts the hydrocarbon storage environment (step 203). The operations further comprise providing the feature vectors to a machine learning model trained to detect hydrocarbon leaks in the hydrocarbon storage environment (step 204). The operations further comprise receiving a machine learning output that indicates when the hydrocarbon leak exists in the hydrocarbon storage environment (step 205).

FIG. 3 illustrates process 300. Process 300 comprises an exemplary operation of environment 100 to confirm sensor readings. Process 300 comprises an example of process 200 illustrated in FIG. 2, however process 200 may differ. In some examples, hydrocarbons (e.g., natural gas) are transferred into and out of tanks 102-104. At some point during the input, output, and storage of the hydrocarbons, tank 102 develops gas leak 105. Sensors 111 sense the volumetric flows of hydrocarbons into and out of tanks 102-104. For example, sensors 111 may comprise flowmeters at the input and output valves of tanks 102-104 to sense the hydrocarbon flows. Sensors 111 generate telemetry data indicating the volume of hydrocarbon input and output from tanks 102-104. The telemetry data may comprise inputs/outputs metrics like cubic feet or rates like cubic feet per day. Sensors 111 transfer the hydrocarbon input/output data to compute engine 120. Sensors 111 may transfer the telemetry data to compute engine 120 over wired links or over wireless links using wireless networking protocols like Bluetooth. Sensors 111 may generate additional telemetry data like temperature, pressure, and venting status for tanks 102-104. Sensors 111 may generate environmental telemetry data for the like windspeed, pressure, temperature, and the like. For example, a valve indicator of sensors 111 may be attached to tank 102 and generates telemetry data that indicates when tanks 102-104 are intentionally venting gaseous hydrocarbons. Sensors 111 may transfer the additional telemetry data to compute engine 120.

Compute engine 120 receives the input/output data from sensors 111 and loads the data to thermodynamic model 122. Thermodynamic model 122 determines the total input volume and total output volume and inputs these metrics into its volumetric balancing algorithms. Thermodynamic model 122 may input other physical metrics like tank temperature, tank pressure, tank fill level, and available tank capacity into the algorithms. The algorithms generate an output based on the input conditions that indicates a discrepancy exists between the volume of gas input into tanks 102-104 and the volume of gas output from tanks 102-104. Compute engine caches the discrepancy indication in memory. The discrepancy indication indicates the total amount of missing hydrocarbons in a volume metric like cubic feet.

Contemporaneously, imaging system 112 views tanks 102-104 and their surrounding environment. For example, imaging system 112 may tilt, pan, and rotate to focus the field of view of imaging system 112 on tanks 102-104. Imaging system 112 generates video footage by viewing tanks 102-104. The video footage comprises a sequence of infrared and/or optical image frames that form a video depicting tanks 102-104 and their surrounding environment. Imaging system 112 transfers video footage to compute engine 120. Imaging system 112 may transfer the video footage to compute engine 120 over wired links or over wireless links using wireless networking protocols like Bluetooth.

Compute engine 120 receives video footage from imaging system 112. Compute engine 120 vectorizes the received data to configure the video footage and the telemetry data for ingestion by machine learning model 121. Compute engine 120 may host an interface application to vectorize the received data. For example, the interface application may implement a feature extraction process on the video footage. The feature extraction processes may comprise assigning numeric values to each pixel in the images that comprise the video footage. The interface application may group the numeric values of corresponding pixels from different ones of the video frames to generate feature vectors which numerically describes how the pixel changes over time. Once generated, the interface application may provide the feature vectors to machine learning model 121.

Machine learning model 121 ingests and processes the feature vectors representing the video footage and the telemetry data using its constituent machine learning algorithms. Machine learning model 121 may comprise background detection algorithms, motion detection algorithms, equipment detection algorithms, segmentation algorithms, and leak identification algorithms. Machine learning model 121 generates a machine learning output that indicates the presence of leak 105 from storage tank 102. For example, machine learning model 121 may utilize its background detection algorithms to identify the background environment (e.g., area surrounding tanks 102-104) in the video footage and subtract the background environment from the video footage. The background detection algorithms may perform two distinct background environment subtractions for long term and short-term portions of the video. For example, the background detection algorithms may identify the background based on 500 image frames of the video footage to perform the long-term background environment subtraction and identify the background based on 30 image frames of the video footage to perform the short-term background environment subtraction.

Model 121 utilizes its motion detection algorithms to identify motion within the video footage. The motion detection algorithms identify differences in corresponding pixels of different frames in the video to identify the motion. For example, model 121 may identify a first pixel in a first image frame and a corresponding first pixel in a consecutive second image frame and identify motion when the corresponding first pixels in the two frames differ. Model 121 utilizes its equipment detection algorithm to locate tanks 102-104 in the video footage. Model 121 utilizes its leak identification algorithms to determine the presence of leak 105. The gas leak identification algorithm may determine the probability that the detected motion comprises a gas leak based on the long-term background subtraction, the short-term background subtraction, the detected motion, the motion duration, the equipment location, and the telemetry data.

Machine learning model 121 uses image segmentation and object detection models to identify equipment and objects in the video footage. Object detection algorithms identify part of the image as segments that correspond to specific devices, people, cars, equipment, and the like. For example, model 121 may identify a group of pixels in a frame that corresponds to a segment that can be identified by a human as a known object. Model 121 utilizes object detection model to reduce false positive from the gas leak detection and correlate the leaks to specific object that may cause the leak.

When the gas leak probability exceeds a threshold value, the leak identification algorithm classifies the detected motion (in this example representing leak 105) as a gas leak. For example, the gas leak identification algorithm may determine the motion was not subtracted in the long-term and short-term background subtractions, is co-located with the location of tank 102, and that tank 102 is not currently venting, and in response determine the probability leak 105 exists is very high (e.g., 95% probability). Model 121 generates a machine learning output that indicates the presence of leak 105, the probability leak 105 exists, the location of leak 105 and tank 102, and the estimated flowrate of leak 105.

Compute engine 120 compares the estimated flowrate of leak 105 predicted by model 121 and the volumetric discrepancy determined by thermodynamic model 122. Compute engine 120 determines that the estimated leak flowrate and the volumetric discrepancy align. Compute engine 120 transfers a notification to downstream systems (e.g., an operator portal) indicating the existence of leak 105 on tank 102. The notification may include contextual information like the measured volumetric discrepancy, the estimated flowrate, geolocation data, time data, and the like. Operators in environment 101 may use the notification to respond to the detected leak.

In examples where machine learning model 121 determines there is no leak in environment 101 but sensors thermodynamic model 122 detects a volumetric discrepancy, compute engine 120 instead transfers a notification indicating a sensor vault exists. The notification may identify the affected sensors, indicate the locations of the affected sensors, may characterize the fault as a sensing error, calibration error, or other type of error. In examples where model 121 does not detect a leak and when model 122 does not detect a discrepancy in the sensor readings, compute engine 120 forwards the sensor outputs to ledger system 131 to mint a non-fungible token to confirm there are no leaks in environment 101. In examples where model 121 does not detect a leak and when model 122 detects a discrepancy, compute engine 120 forwards the sensor outputs to ledger system 131 to mint a non-fungible token to confirm there are no leaks in environment 101 and transfers a notification indicating a sensor vault exists.

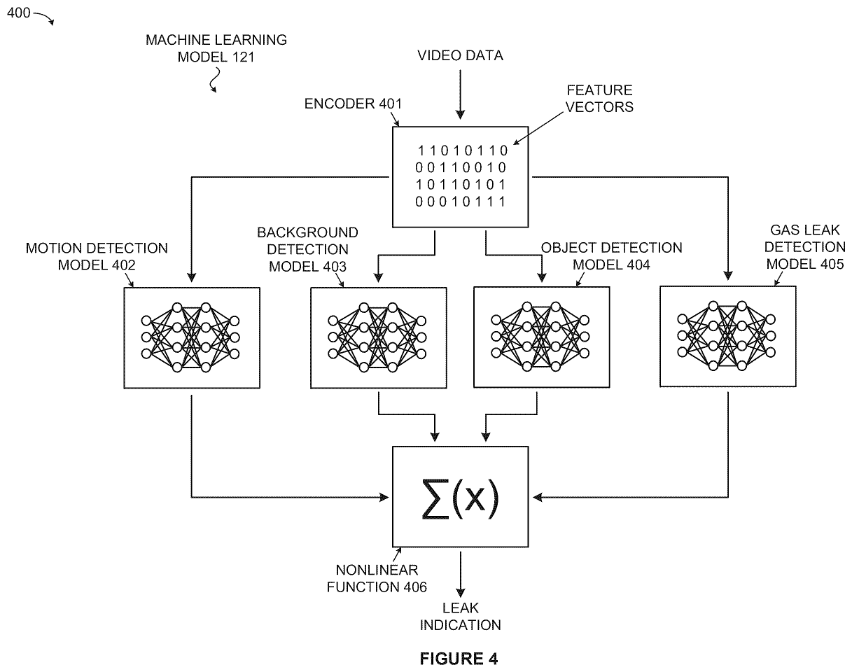

FIG. 4 illustrates view 400. View 400 illustrates an example of machine learning model 121 in environment 101. In other examples, model 121 may differ. Machine learning model 121 comprises encoder 401, motion detection model 402, background detection model 403, object detection model 404, gas leak detection model 405, and nonlinear function 406. Encoder 401 comprises one or more computing modules to convert video data into a machine learning model consumable form. In this example, encoder 401 converts video data generated by imaging system 112 into feature vectors. The feature vectors are representative of machine learning inputs to models 402-405 that comprise a numerical representation of infrared or optical video data that depicts environment 101. Motion detection model 402 comprises a machine learning model trained to ingest the feature vectors and identify motion in the infrared or optical video data. Background detection model 403 comprises a machine learning model trained to ingest feature vectors 401 and identify the background environment in the infrared or optical video data. Object detection model 404 comprises a machine learning model trained to ingest feature vectors 401 and segment the image in the infrared or optical video data to identify and classify hydrocarbon storage, extraction, and or transfer equipment. Gas leak detection model 405 comprises a machine learning model trained to ingest feature vectors 401 and identify gas leaks in the infrared or optical video data. Nonlinear function 406 comprises a machine learning model configured to ingest outputs from models 402, 403, 404, and 405 and generate a gas leak probability indication. Models 402-405 and function 306 may be hosted by the same computing device or different computing devices.

In some examples, compute engine 120 receives infrared or optical video data depicting environment 101 and loads the video data into model 121. Encoder 401 vectorizes the infrared or optical video data to generate the feature vectors. For example, encoder 401 may numerically represent the pixels in the image frames that comprise the infrared video data and form the feature vectors using the numeric representations. Encoder 401 transfers the feature vectors to models 402-405. Motion detection model 402, background detection model 403, object detection model 404, and gas leak detection model 405 ingest the feature vectors.

Motion detection model 402 determines regions of the infrared or optical video data that depict motion, including motion representing gas leak 105 in the infrared or optical video data. For example, motion detection model 402 may compare corresponding pixels in sequential video frames of the infrared or optical video data to identify changes between the corresponding pixels (e.g., changes in color). Model 402 may then classify the identified changes in the pixels as motion depicted in the infrared or optical video data.

As stated above, the infrared or optical video data depicts environment 101 which comprises machinery and equipment (e.g., tanks 102-104) that extract, store, and transport hydrocarbons. The machinery and equipment that extract, store, and transport hydrocarbons are viewable in the infrared or optical video data and may develop gas leaks that are also viewable in the infrared or optical video data. Other features depicted in the infrared or optical video data may be classified as background environment. Exemplary background environment comprises the sky, the ground, plant and animal life, equipment not associated with gas extraction (e.g., an automobile), buildings, and the like. Background detection model 403 determines regions of the infrared or optical video data that depict the background environment. For example, background detection model 403 may compare corresponding pixels in sequential video frames of the infrared or optical video data to identify regions of the infrared or optical video data that are relatively unchanging to identify the background environment. Background detection model 403 may perform long-term and short-term background detection. Long-term background detection may comprise a background detection process using 500 frames of infrared or optical video data. The short-term background detection may comprise a background detection process using 30 frames of infrared or optical video data. Background detection model 403 may combine short and long-term background detection analysis to fully identify the background environment depicted in the infrared or optical video data.

Object detection model 404 ingests the feature vectors that represent the infrared or optical video data and segments parts of the frames that correspond to a known object (e.g., tanks 102-104) in the field of view of the camera. Using object detection helps reduce gas leak detection false positive and relates each leak with some probability to an actual device in the field. Understanding which piece of equipment is causing the leak helps to better manage and focus on design and deployment of different devices. Object detection model 404 generates an output that indicates regions of the infrared or optical video data that depict tanks 102-104 and potentially other hydrocarbon extraction, storage, and transfer equipment present in environment 101.

Gas leak detection model 405 ingests the feature vectors that represent the infrared or optical video data and identifies the movement in the video data that corresponds to leak 105. Gas leak detection model 405 detects a segment of an image in series of images as a leak based on the similarity of movement to a gas. Gas leak detection model 405 may calculate the flowrate of the gas leak based on distance of the camera to the leak, speed of leak movement in the video, pixel resolution of the video, and environmental conditions like wind speed and direction.

Motion detection model 402, background detection model 403, object detection model 404, and gas leak detection model 405 transfer their machine learning outputs to nonlinear function 406. Nonlinear function 406 is a machine learning model that is configured to combine the machine learning outputs generated by models 402-405 to determine and infer the presence of gas leak 105. Nonlinear function 406 subtracts the portions of the infrared or optical video data identified as background environment from the portions of the infrared or optical video data identified as depicting motion to identify all regions of the video data that depict motion that is not part of the background environment. For example, this may subtract portions of the video data that depict the motion of clouds. Nonlinear function 406 then subtracts regions of the infrared or optical video depicting tanks 102-104 from the remainder resulting from the background subtraction to identify all regions of the video data that depict both motion and tanks 102-104. Nonlinear function 406 then compares the remainder of the image resulting from the equipment subtraction and the background subtraction to the region of the video data identified by gas leak detection model 405 as a possible gas leak. When the remainder of the video data resulting from the subtractions overlaps with the region of the video data identified by gas leak detection model 405 as a possible gas leak, nonlinear function 406 confirms the presence of a gas leak. Generally, motion depicted by the infrared or optical video data that is not part of the background environment, that is co-located with a piece hydrocarbon storage/transfer equipment, and that has been identified as a possible gas leak by detection model 405 may be classified as a gas leak. By performing multiple image subtractions, nonlinear function 406 inhibits false-positive gas leak detection by detection model 405. Nonlinear function 406 outputs an indication of as to whether a gas leak has been detected in the infrared or optical video data. The indication may comprise a probability/confidence metric regarding the existence of the gas leak (e.g., 85% chance detected leak is real). The indication may comprise a gas flow rate estimate for the detected gas leak and equipment identification numbers to indicate the location of the gas leak. Nonlinear function 406 may transfer the gas leak indication to user computing systems for review by human operators.

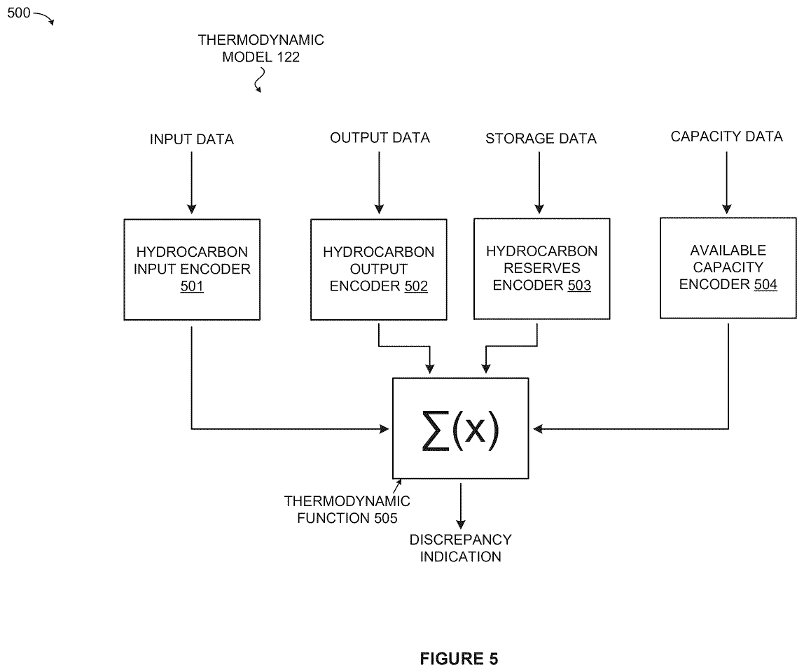

FIG. 5 comprises view 500. View 500 illustrates an example of thermodynamic model 122 in environment 101. In other examples, model 122 may differ. Thermodynamic model 122 comprises encoders 501-504 and thermodynamic function 505. Encoder 501 comprises a computing module to convert mass/volumetric input data generated by sensors 111 into a form interpretable by function 505. Encoder 502 comprises a computing module to convert mass/volumetric output data generated by sensors 111 into a form interpretable by function 505. Encoder 503 comprises a computing module to convert mass/volumetric storage data generated by sensors 111 into a form interpretable by function 505. Encoder 504 comprises a computing module to convert tank capacity data generated by sensors 111 into a form interpretable by function 505. Thermodynamic function 505 comprises one or more mass/volume balancing algorithms to determine if the total hydrocarbon mass/volume flowing into, out of, and stored by tanks 102-104 is consistent. The balancing algorithms may take the data generated by encoders 501-504 as inputs as well as other data like tank temperature, tank pressure, fuel compressibility, and the like. Although illustrated as multiple separate encoders, in other examples encoders 501 may comprise a single encoder or may be omitted from model 122 entirely.

In some examples, compute engine 120 receives sensor data characterizing hydrocarbon inputs, outputs, stored reserves, and tank capacity from sensors 111. Compute engine 120 loads the sensor data into thermodynamic model 501-504. Encoders 501-504 convert the raw sensor data into a form interpretable by function 505. For example, encoder 501-504 may standardize the units in the input data into a unit recognizable by function 505. Encoders 501-504 transfers the hydrocarbon input data, hydrocarbon output data, stored hydrocarbon reserves data, and tank capacity data to function 505. Typically, the input data characterizes the operation of environment 101 over some time period (e.g., an hour, day, week, etc.). For example, the hydrocarbon input data may comprise the measured input volume of natural gas in cubic feet per minute over the course of an hour. Thermodynamic function 505 receives the inputs from encoders 501-504. Function 505 loads the inputs into its constituent algorithms to generate an output indicating if a volume or mass discrepancy exists in the sensor data. For example, function 505 may determine the total mass/volume entered into tanks 102-104 and the total mass taken out of tanks 102-104. When the input and output masses/volumes match, function 505 confirms that no discrepancy exists. If the input and output mass/volume does not match, function 505 may determine if there is sufficient storage capacity and/or hydrocarbon reserves to account for the difference in mass/volume inputs and mass/volume outputs. When there is sufficient storage capacity and/or reserves to account for the mass/volume difference, function 505 confirms that no discrepancy exists. If there is insufficient storage capacity or hydrocarbon reserves to account for the mass/volume difference, function 505 determines that a discrepancy exists and transfers a notification indicating the discrepancy. When the discrepancy is a result of sensor fault (as opposed to a leak), the notification may indicate the ones of sensors 111 that are faulty, characterize the error (e.g., calibration error), and indicate the locations of the faulty sensors. Operators may use the indication to address the sensor faults (e.g., calibration, replacement, maintenance, etc.).

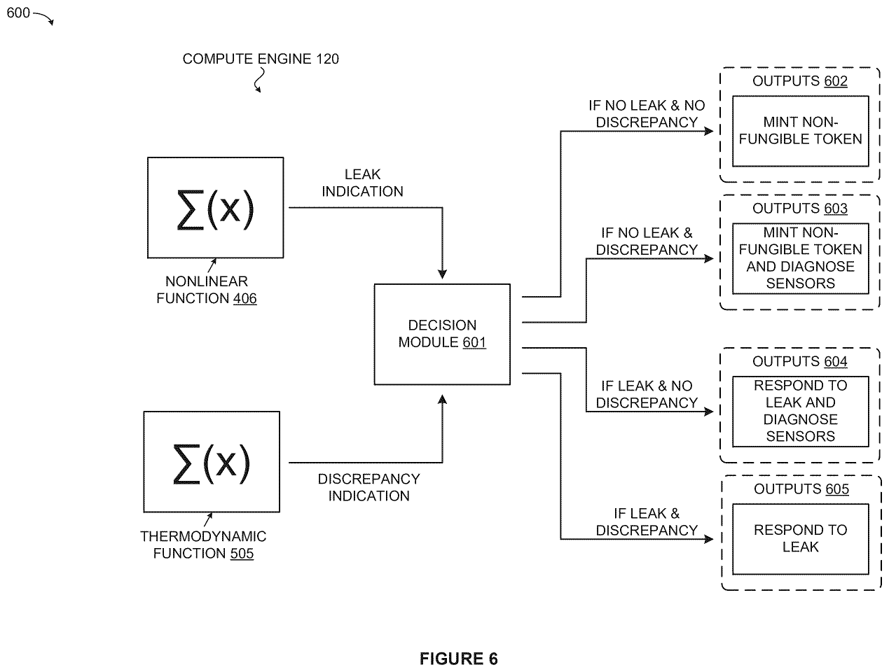

FIG. 6 comprises view 600. View 600 illustrates an example of compute engine 120 in environment 101. In other examples, compute engine 120 may differ. Compute engine 120 comprises nonlinear function 406, thermodynamic function 505, decision module 601, and outputs 602-605. Decision module 601 comprises a computing module to generate an output based on the leak indication generated by nonlinear function 406 and the discrepancy indication generated by thermodynamic function 505. Outputs 602-605 are representative of decisions generated by decision module 601.

In some examples, decision module 601 receives a leak indication from nonlinear function 406 and a discrepancy indication from thermodynamic function 505. When the leak indication states that there is not a leak (or the flowrate of the detected leak is below a threshold value) and the discrepancy indication states that there is not discrepancy between the sensor inputs and sensor outputs, decision module 601 generates output 602. Output 602 recommends minting a non-fungible token certifying environment 101 is not leaking hydrocarbons into the environment. In response to output 602, compute engine 120 interfaces with ledger system 131 to mint the non-fungible token. When the leak indication states that there is not a leak (or the flowrate of the detected leak is below a threshold value) and the discrepancy indication states that there is discrepancy between the sensor inputs and sensor outputs, decision module 601 generates output 603. Output 603 recommends minting a non-fungible token certifying environment 101 is not leaking hydrocarbons into the environment and performing a diagnostic operation to detect sensor faults. In response to output 603, compute engine 120 interfaces with ledger system 131 to mint the non-fungible token and interrogates sensors 111 to locate the faulty sensor(s). For example, engine 120 may determine one of sensors 111 is improperly calibrated and in response, calibrate the faulty sensor. Alternatively, compute engine 415 may instead generate and transfer an alert to the site operators that indicates the faulty ones of sensors 111.

When the leak indication states that there is a leak (or the flowrate of the detected leak is below a threshold value) and the discrepancy indication states that there is not discrepancy between the sensor inputs and sensor outputs, decision module 601 generates output 604. Output 604 recommends responding to the detected leak and performing a diagnostic operation to detect sensor faults. In response to output 604, compute engine 120 transfers an alert to operators that identifies the leak, the leaking equipment, and the estimated flowrate. Compute engine 120 also interrogates sensors 111 to locate the faulty sensor(s) and corrects the sensor faults autonomously and/or transfers an alert to the site operators that indicates the faulty ones of sensors 111. When the leak indication states that there is a leak (or the flowrate of the detected leak is below a threshold value) and the discrepancy indication states that there is discrepancy between the sensor inputs and sensor outputs, decision module 601 generates output 605. Output 605 recommends responding to the detected leak. In response to output 605, compute engine 120 transfers an alert to operators that identifies the leak, the leaking equipment, and the estimated flowrate. In some examples, outputs 602-605 may be used as training data for machine learning systems (e.g., a generative artificial intelligence) and/or may be used to simulate gas leaks in 3D virtual models of environment 101.

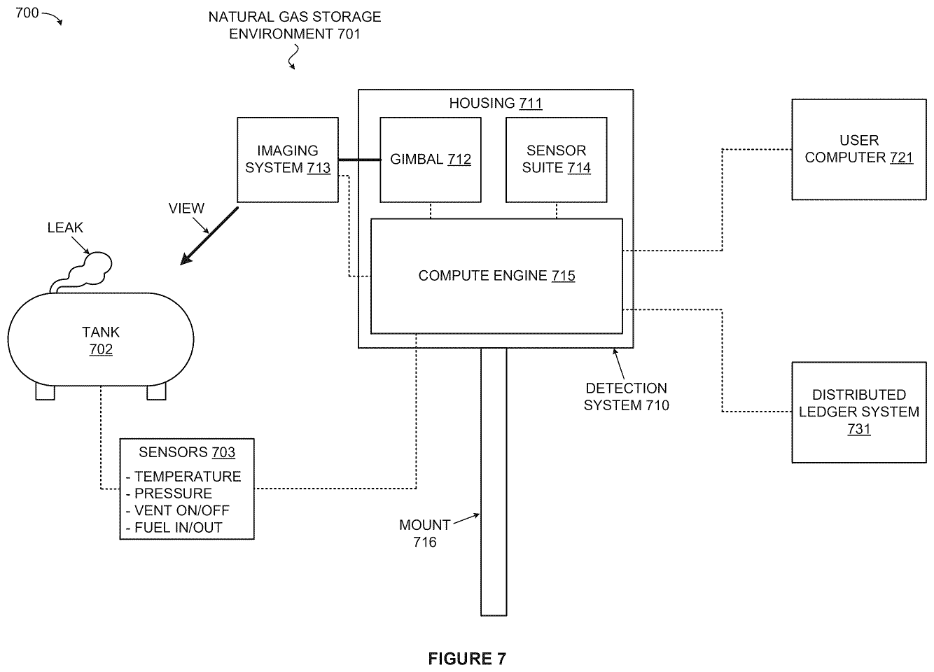

FIG. 7 comprises view 700. View 700 illustrates natural gas storage environment 701. Environment 701 comprises an example of environment 101 illustrated in FIG. 1, however environment 101 may differ. Environment 701 is representative of storage facility for natural gas. Natural gas storage environment 701 comprises tank 702, sensors 703, detection system 710, user computer 721, and distributed ledger system 731. Detection system 710 comprises housing 711, gimbal 712, imaging system 713, sensor suite 714, and compute engine 715. Environment 701 typically comprises other objects like buildings, trucks, and human operators however these other entities are omitted for clarity. In other examples, environment 701 may include fewer or additional components than those illustrated in FIG. 7. Likewise, the illustrated components of environment 701 may include fewer or additional components, assets, or connections than shown. Detection system 710, user computer 721, and distributed ledger system 731 may each be representative of single computing apparatuses or multiple computing apparatuses.

In some examples, compute engine 715 controls gimbal 712 to position imaging system 713 to view tank 702. Imaging system 713 and sensor suite 714 view tank 702 and transfer thermal video, visible spectrum video, and distances to compute engine 715. Imaging system 713 and sensor suite 714 transfer their data to compute engine 715. Compute engine 715 receives thermal images from imaging system 713 and distances and visible spectrum images from sensor suite 714. Compute engine 715 hosts a machine learning application to detect gas and characterize gas leaks based on the thermal, video, and distance data. Sensors 703 generate tank telemetry data that includes data characterizing natural gas inputs and outputs from tank 702. Sensors 703 transfer the tank telemetry data to compute engine 715. Compute engine 715 receives tank telemetry data from sensors 703. Compute engine 715 hosts a thermodynamic application to detect discrepancies between the amount of natural gas entering and exiting tank 702.

When compute engine 715 determines that there are no leaks in environment 701 or that the leaks in environment 701 are below a flowrate threshold, computing engine 715 interfaces with ledger system 731 to mint a non-fungible token certifying environment 701 as a clean site. When compute engine 715 determines that a leak in environment 703 exceeds the flowrate threshold, compute engine 715 transfers an alert to user computer 721 that indicates the presence of the leak, the location of the leak, footage of the leak, and an estimated flowrate. When compute engine 715 detects a leak and determines a discrepancy between the gas input and gas output sensor data, compute engine 715 compares the discrepancy to the leak flowrate. When the discrepancy does not align with the estimated flowrate, compute engine 715 interrogates sensors 703 to detect sensor faults. Likewise, when compute engine 715 does not detect a leak but determines a discrepancy between the gas input and gas output sensor data, compute engine 715 interrogates sensors 703 to detect sensor faults. Compute engine 715 may transfer an alert to user computer 721 that indicates the faulty sensors, fault types (e.g., calibration error), and the like. User computer 721 displays alerts received from compute engine 715 for review by an operator.

Tank 702 comprises a bullet tank that stores natural gas and comprises a gas leak. The gas leak may be caused by a defect like a broken gasket or improper seal or may be intentional venting. Sensors 703 is representative of a sensor suite comprising a fuel input flowmeter, output flowmeter, on/off venting indicator, tank and environment thermometers, a tank pressure gauge, an atmospheric barometer, environmental hygrometer, and a wind gauge. A portion of sensors 703 are coupled to tank 702 via wired links. For example, the flowmeters, on/off venting indicator, tank thermometer, and tank pressure gauge may be mounted directly on tank 702 while the remaining sensors may be positioned in the environment proximate to tank 702 (e.g., on a weather station).

Detection system 710 comprises housing 711, gimbal 712, imaging system 713, sensor suite 714, compute engine 715, and mount 716. Housing 711 comprises a weatherproof encloser that mounts the components of detection system 710. For example, housing may comprise an aluminum shell with weatherproof gaskets to inhibit dust and moister from entering detection system 710. Housing 711 in coupled to mount 716 to elevate imaging system 713 to provide a wider field of view for imaging system 713.

Gimbal 712 is representative of a pan and tilt system that orients imaging system 713 to view tank 702 and stabilizes the field of view. Gimbal 712 comprises actuators and rotors to control the pitch, roll, and yaw of imaging system 713. For example, a control application hosted by engine 715 may generate control signaling that drives gimbal 712 to move the gimbal arm and imaging system 713 to pre-defined views and control the direction of imaging system 713 to provide a 360-degree field of view. Gimbal 712 may receive the instructions (e.g., from compute engine 715) and responsively position imaging system 713 to view tank 702. Gimbal 712 may implement a control loop to stabilize the field of view of imaging system 713. For example, mount 716 may sway in windy conditions. Gimbal 121 may update the pitch, roll, and yaw of imaging system 713 to account for the sway of mount 716. Exemplary control loops include feedback loops, Proportional-Integral-Derivative (PID) control loops and the like.

Imaging system 713 comprises a Forward Looking Infrared (FLIR) camera attached to gimbal system 713 via a gimbal arm. Imaging system 713 records tank 702 and its surrounding environment including any buildings, vehicles, human operators, and the like in the infrared spectrum. Sensor suite 714 comprises a laser rangefinder and a video camera. The laser rangefinder measures distances between tank 702 and detection system 710. The video camera records tank 702 and its surrounding environment including any buildings, vehicles, human operators, and the like in the visible spectrum. Sensors 703, imaging system 713, and sensor suite 714 are communicatively coupled to compute engine 715 over wired and/or wireless links. The links may comprise a private Local Area Network (LAN) or may traverse public internet links supported by internet backbone providers.

Compute engine 715 comprises one or more computing devices to control the operation of detection system 710. Compute engine 715 comprises microprocessors, memories, and transceivers connected over bus circuitry. The memories store operating systems, control applications, vectorization applications, machine learning applications, thermodynamic applications, and the like. The microprocessors comprise CPUs, GPUs, DSPs, ASICs, FPGAs, analog computing circuits, and/or the like. The memories comprise RAM, flash circuitry, HDDs, SSDs, NVMe SSDs, and/or the like. The microprocessors retrieve and execute the software from the memories to drive the operation of detection system 710.

User computer 721 is a computing device communicatively coupled to compute engine 715 to review machine learning outputs, recommendations, non-fungible token minting events, and the like generated by compute engine 715. User computer 721 comprises microprocessors, memories, user components, displays, and transceivers connected over bus circuitry. The memories store operating systems, user applications, Graphical User Interface (GUI) applications, and the like. The microprocessors comprise CPUs, GPUs, DSPs, ASICS, FPGAs, analog computing circuits, and/or the like. The memories comprise RAM, flash circuitry, HDDs, SSDs, NVMe SSDs, and/or the like. The microprocessors retrieve and execute the software from the memories to drive the operation of user computer 721.

Distributer ledger system 731 is a collection of computing devices communicatively coupled to compute engine 715 and to each other that mint non-fungible tokens for environment 701 and host a blockchain to immutably store the non-fungible token data. Each computing device in ledger system 731 stores a copy of the blockchain. Distributed ledger system 731 comprises microprocessors, memories, and transceivers connected over bus circuitry. The memories store operating systems, ledger applications, and copies of the blockchain. The microprocessors comprise CPUs, GPUs, DSPs, ASICs, FPGAs, analog computing circuits, and/or the like. The memories comprise RAM, flash circuitry, HDDs, SSDs, NVMe SSDs, and/or the like. The microprocessors retrieve and execute the software from the memories to drive the operation of distributed ledger system 731.

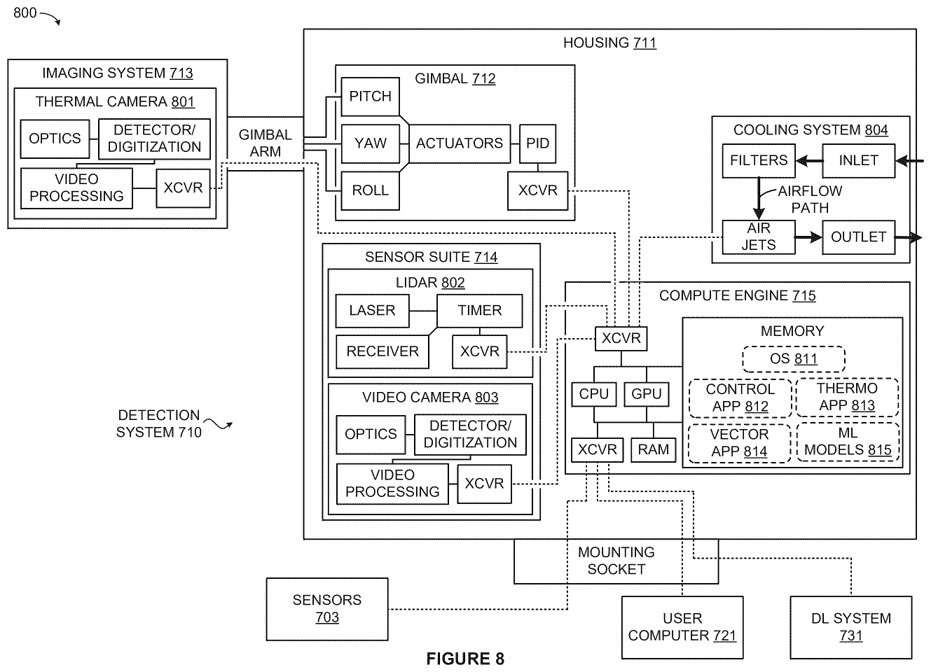

FIG. 8 comprises view 800. View 800 further illustrates detection system 710. Detection system 710 comprises an example of imaging system 112 and compute engine 120 illustrated in FIG. 1, however imaging system 112 and compute engine 120 may differ. Housing 711 provides structural support to gimbal 712, imaging system 713, sensor suite 714, cooling system 804, and compute engine 715. Gimbal 712, sensor suite 714, cooling system 804, and compute engine 715 are mounted internally in housing 711 while imaging system 713 and the gimbal arm are mounted externally to housing 711. Housing 711 may comprise an aluminum frame, a stainless-steel frame, a rigid plastic frame, rubber gaskets, screws, and/or other elements to enclose and protect the interior components. Housing 711 comprises a mounting socket to detachably couple housing 711 to a mount 716.

Gimbal 712 comprise pitch, yaw, and roll rotors/stators, actuators, a PID controller, and a transceiver (XCVR) coupled over bus circuitry. The actuators comprise electric motors that adjust the positions of the pitch, yaw, and roll rotors/stators in response to control signaling received from compute engine 715. The pitch, yaw, and roll rotors/stators move gimbal arm 412 and imaging system 713 to focus thermal camera 421 at a desired field of view, typically to image hydrocarbon, natural gas, petroleum, refined petroleum, or petrochemical storage, transfer, and extraction equipment.

Imaging system 713 is coupled to housing 711 by gimbal arm 412 and mounts thermal camera 801. Thermal camera 801 comprises optics, photon detection and digitization circuitry, video processing circuitry, and a transceiver connected over bus circuitry. The optics comprise components like lenses to capture photons in the infrared spectrum and reflect radiation in the visible and ultraviolet spectrums. Photons reflected and emitted by hydrocarbon equipment in the infrared spectrum enter the optics and are passed to the detector/digitation circuitry. The detector/digitization circuitry comprises a Focal Plane Array (FPA) of micrometer size pixels constructed from infrared sensitive materials. The detector/digitation circuitry detects the photons and generates a corresponding digital signal that represents the temperature of the hydrocarbon equipment and surrounding environment and passes this signal to the video processing circuitry. The video processing circuitry comprises components like DSPs to translate the digital signal into an infrared image of the equipment. The transceiver transfers the resulting thermal image to compute engine 715 over a communication link.

Sensor suite 714 is embedded in the body of housing 711 and mounts lidar 802 and video camera 803. Sensor suite 714 comprises a female socket that may receive a compatible sensor package. In this example, the sensor package comprises lidar 802 and video camera 803. Lidar 802 comprises a laser rangefinder to measure the distance between hydrocarbon storage, extraction, and transfer equipment and system 710. Lidar 802 comprises a laser, receiver, timer, and a transceiver connected over bus circuitry. Lidar 802 may comprise a metallic and/or rigid plastic housing to encase the circuitry. The laser emits a laser beam towards a monitored piece of equipment in response to control signaling received from compute engine 715. The beam reflects off of the equipment and is detected by the receiver. The timer measures the amount of time that elapsed between emission and detection of the beam and correlates that amount of time to a distance. The transceiver transfers the resulting distance calculation to compute engine 715 over a communication link.

Video camera 803 comprises a camera to image hydrocarbon storage, extraction, and transfer equipment in the visible spectrum. Video camera 803 comprises optics, photon detection and digitization circuitry, video processing circuitry, and a transceiver connected over bus circuitry. The optics comprise components like lenses to capture photons in the visible spectrum and reflect radiation in the infrared and ultraviolet spectrums. Photons reflected and emitted by hydrocarbon equipment in the visible spectrum enter the optics and are passed to the detector/digitation circuitry. The detector/digitization circuitry comprises an FPA of micrometer size pixels constructed from visible spectrum sensitive materials. The detector/digitation circuitry detects the photons and generates a corresponding digital signal that represents the view of the hydrocarbon equipment and surrounding environment and passes this signal to the video processing circuitry. The video processing circuitry comprises components like DSPs to translate the digital signal into a video of the equipment. The transceiver transfers the resulting video to compute engine 715 over a communication link.

Cooling system 804 is representative of a temperature regulator to pass air over compute engine 715 and shed the heat generated by engine 715 to the exterior environment. Colling system 804 comprises an air inlet, filters, air jets, and an outlet. Although illustrated as being separate from compute engine 715, cooling system 804 and engine 715 are typically integrated so that the airflow pathway traverses the computing elements of engine 715. Air jets pull air into housing 711 though inlet. The filters block particulate matter (e.g., dust, sand, etc.) and moister (e.g., water droplets, rain, etc.) from entering housing 711. Air jets blow the air over the computing elements of engine 451. Heat generated by the commuting elements transfers to the flowing air through convective and conductive heat transfer. The air jets drive the heated air out of housing 711 through the outlet. The air outlet may also comprise filters to inhibit particulate matter and moister from entering housing 711.

Compute engine 715 is a computing device comprising transceivers, CPU, GPU, RAM, and memory coupled over bus circuitry. The transceivers are coupled to the other components of system 710, to user computer 721, and ledger system 731. Compute engine 715 typically comprises other computing elements like power supply, however these are omitted for clarity. The memory stores operating system 811, control application 812, thermodynamic application 813, vectorization application 814, machine learning models 815, and typically other software like user application, communication protocols, firmware, and the like. Operating system 811 comprises software to manage the hardware and software resources in compute engine 715. Control application 812 comprises software to control the operation of gimbal 712, camera 801, lidar 802, video camera 803, and cooling system 804. Thermodynamic application 813 comprises an application to model natural gas flow through tank 702 and detect discrepancies between natural gas input and output from tank 702 reported by sensors 703. Vectorization application 814 comprises an application to convert machine learning inputs into a consumable format for machine learning models 815. Machine learning models 815 comprise machine learning algorithms trained to detect leaks and fill levels in natural gas storage equipment.

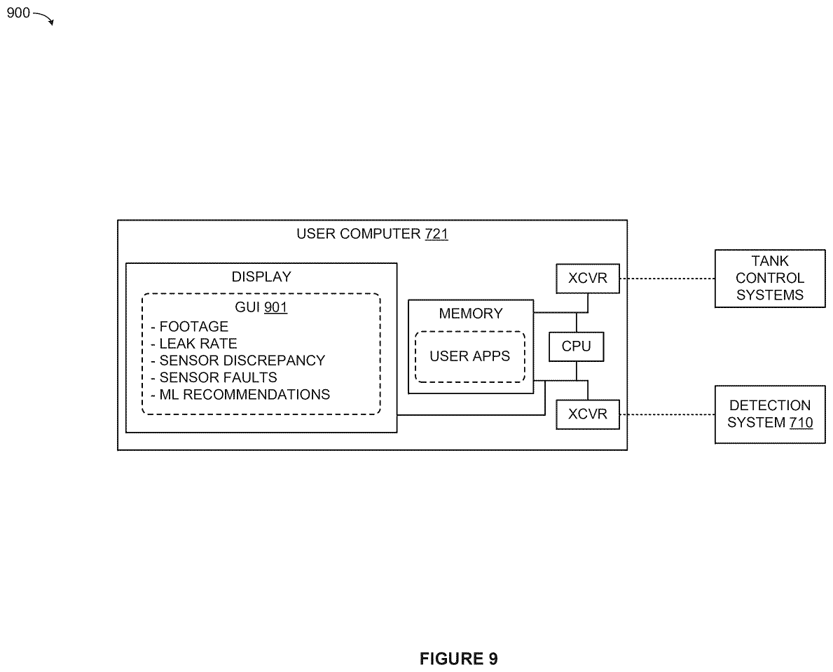

FIG. 9 comprises view 900. View 900 further illustrates user computer 721. Computer 721 comprises transceivers, CPU, memory, and a display coupled over bus circuitry. A transceiver in computer 721 is coupled to detection system 710 and another transceiver is coupled to control systems for tank 702. User computer 721 hosts user application and comprises a display that renders GUI 901. GUI 901 comprises text and graphics to depict leak indications, infrared video footage, the predicted leak flowrate, tank ID number, tank location, sensor discrepancies, sensor faults, machine learning recommendations, and the like. User computer 721 generates and transfers alerts in response to user input to notify tank control systems and human operators in extraction environment 701 when gas leaks and sensor discrepancies are detected.

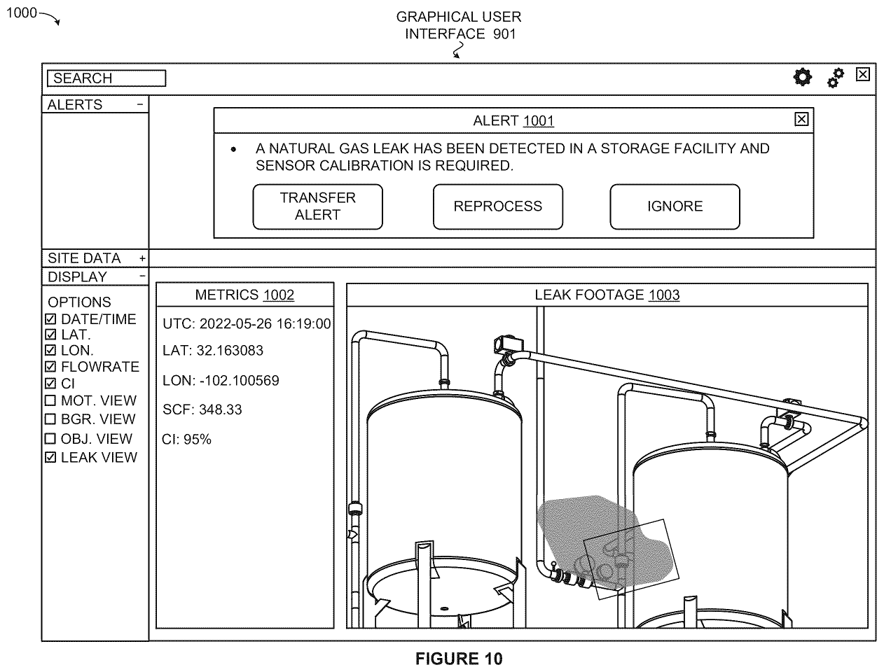

FIG. 10 comprises view 1000. View 1000 further illustrates GUI 901. GUI 901 comprises alert 1001, metrics 1002, and leak footage 1003. Alert 1001 comprises a warning that indicates a natural gas leak has been detected and that sensor calibration is required. For example, user computer 721 may receive a leak indication and sensor calibration requirement generated by compute engine 715 and responsively display alert 1001. Alert 1001 comprises selectable options to transfer an alert, to reprocess, or to ignore the alert. Metrics 1002 comprise information like date/time, latitude and longitude coordinates, leak flowrate, and prediction confidence that contextualizes the detected gas leak. Leak footage 1003 comprises video data depicting the detected gas leak. Leak footage 1003 is marked with a box and highlights to identify the location of the gas leak within the footage. The thermal video annotations may be created by a machine learning model (e.g., models 815). GUI 901 comprises a set of selectable options on the left-side panel that allows a user to customize the view of leak footage 1003 and the information presented in metrics 1002.

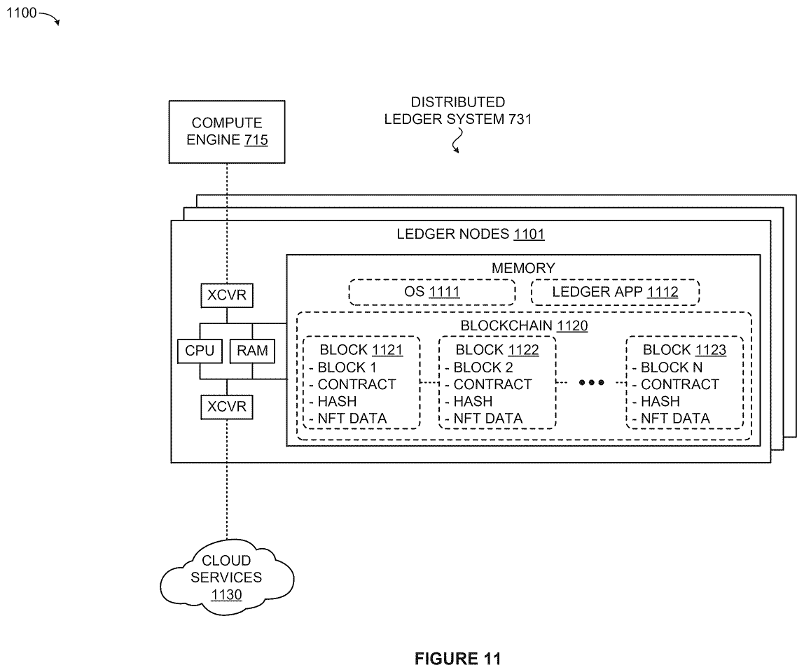

FIG. 11 comprises view 1100. View 1100 further illustrates distributed ledger systems 731. Ledger system 731 comprises ledger nodes 1101. Ledger nodes 1101 are representative of computing devices to host a distributed ledger. Ledger nodes 1101 comprise transceivers, CPU, RAM, and memory coupled over bus circuitry. Transceivers in nodes 1101 are coupled to compute engine 715, to each other, and to cloud services 1130. The memory stores OS 1111, ledger application 1112, and blockchain 1120. Blockchain 1120 comprises blocks 1121-1123. OS 1111 manages the software and hardware resources of nodes 1101. Ledger application 1112 processes transactions to add new blocks to blockchain 1120. In particular, ledger nodes 1101 may receive minting requests to create non-fungible tokens from compute engine 715 to certify environment 701 as clean (e.g., that gas leaks are not present or are below a threshold). Each of ledger nodes 1101 processes the request to either approve or reject the request. When nodes 1101 reach a consensus approving the addition of a new block, nodes 1101 mint the non-fungible token and commit a new block to the blockchain that comprises the token data. Blockchain 1120 comprises blocks 1121-1123. Although illustrated as comprising three blocks, blockchain 1120 may comprise any number of blocks. Blocks 1121-1123 comprise block IDs, contracts, hashes for the previous block, and non-fungible token data. Ledger nodes 1101 may interface with cloud services 1130 to sell the minted tokens on a marketplace.

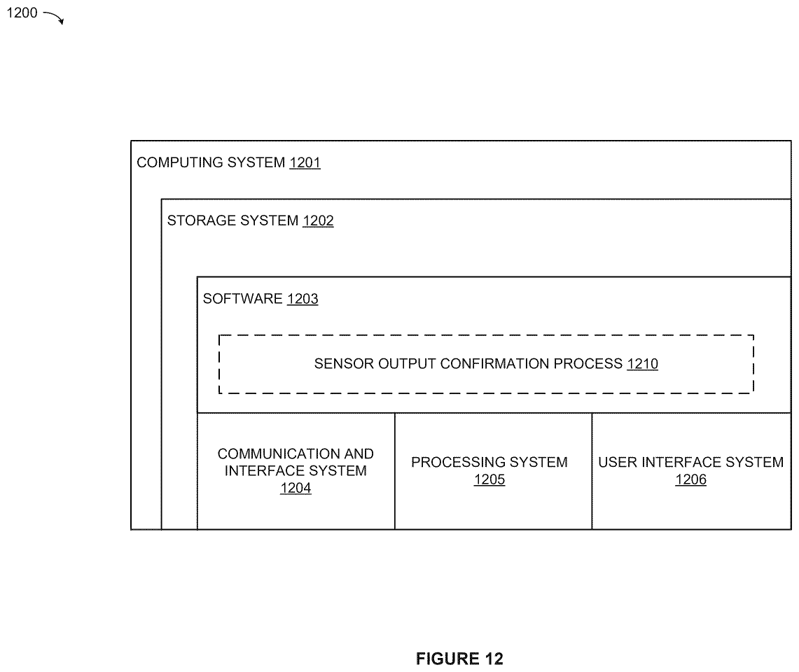

FIG. 12 comprises view 1200. View 1200 illustrates computing system 1201. Computing system 1201 is representative of any system or collection of systems with which the various operational architectures, processes, scenarios, and sequences disclosed herein for detecting leaks and sensor discrepancies in hydrocarbon extraction, transfer, and storage environments. For example, computing system 1201 may be representative of compute engine 120, ledger system 131, compute engine 715, user computer 721, distributed ledger system 731, and/or any other computing device contemplated herein. Computing system 1201 may be implemented as a single apparatus, system, or device or may be implemented in a distributed manner as multiple apparatuses, systems, or devices. Computing system 1201 includes, but is not limited to, storage system 1202, software 1203, communication interface system 1204, processing system 1205, and user interface system 1206. Processing system 1205 is operatively coupled with storage system 1202, communication interface system 1204, and user interface system 1206.

Processing system 1205 loads and executes software 1203 from storage system 1202. Software 1203 includes and implements sensor output confirmation process 1210, which is representative of any of the leak detection processes and sensor confirmation processes described with respect to the preceding Figures, including but not limited to the video imaging, machine learning, leak detection and classification, sensor discrepancy detection, distributed ledger, and user interface operations described with respect to the preceding Figures. For example, process 1210 may be representative of process 200 illustrated in FIG. 2 and/or process 300 illustrated in FIG. 3. When executed by processing system 1205 to confirm sensor outputs, software 1203 directs processing system 1205 to operate as described herein for at least the various processes, operational scenarios, and sequences discussed in the foregoing implementations. Computing system 1201 may optionally include additional devices, features, or functionality not discussed for purposes of brevity.

Processing system 1205 may comprise a micro-processor and other circuitry that retrieves and executes software 1203 from storage system 1202. Processing system 1205 may be implemented within a single processing device but may also be distributed across multiple processing devices or sub-systems that cooperate in executing program instructions. Examples of processing system 1205 include general purpose CPUs, GPUs, DSPs, ASICs, FPGAs, analog computing devices, and logic devices, as well as any other type of processing device, combinations, or variations thereof.

Storage system 1202 may comprise any computer readable storage media readable by processing system 1205 and capable of storing software 1203. Storage system 1202 may include volatile, nonvolatile, removable, and/or non-removable media implemented in any method or technology for storage of information, such as computer readable instructions, data structures, program modules, or other data. Examples of storage media include RAM, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1202 may also include computer readable communication media over which at least some of software 1203 may be communicated internally or externally. Storage system 1202 may be implemented as a single storage device but may also be implemented across multiple storage devices or sub-systems co-located or distributed relative to each other. Storage system 1202 may comprise additional elements, such as a controller, capable of communicating with processing system 1205 or possibly other systems.

Software 1203 (including process 1210) may be implemented in program instructions and among other functions may, when executed by processing system 1205, direct processing system 1205 to operate as described with respect to the various operational scenarios, sequences, and processes illustrated herein. For example, software 1203 may include program instructions for generating feature vectors that represent a video depicting a natural gas extraction system and generating a machine learning output to identify and classify natural gas leaks and confirm sensor readings in the extraction system as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1203 may include additional processes, programs, or components, such as operating system software, virtualization software, or other application software. Software 1203 may also comprise firmware or some other form of machine-readable processing instructions executable by processing system 1205.

In general, software 1203 may, when loaded into processing system 1205 and executed, transform a suitable apparatus, system, or device (of which computing system 1201 is representative) overall from a general-purpose computing system into a special-purpose computing system customized to confirm sensor outputs in a hydrocarbon storage environment. Indeed, encoding software 1203 on storage system 1202 may transform the physical structure of storage system 1202. The specific transformation of the physical structure may depend on various factors in different implementations of this description. Examples of such factors may include, but are not limited to, the technology used to implement the storage media of storage system 1202 and whether the computer-storage media are characterized as primary or secondary storage, as well as other factors.

For example, if the computer readable storage media are implemented as semiconductor-based memory, software 1203 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1204 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and an extended discussion of them is omitted for the sake of brevity.

While some examples provided herein are described in the context of computing devices for sensor reading confirmation and gas leak detection and classification, it should be understood that the condition systems and methods described herein are not limited to such embodiments and may apply to a variety of other environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method of operating a leak detection system to confirm sensor outputs in a hydrocarbon storage environment, the method comprising:
obtaining sensor data that characterizes hydrocarbon inputs and hydrocarbon outputs in the hydrocarbon storage environment;
processing the sensor data using a thermodynamic model to determine when a discrepancy exists between the hydrocarbon inputs and the hydrocarbon outputs;
generating feature vectors that represent video data that depicts the hydrocarbon storage environment;
providing the feature vectors as input to a machine learning engine trained to detect hydrocarbon leaks in the hydrocarbon storage environment; and
receiving a machine learning output that indicates when a hydrocarbon leak exists in the hydrocarbon storage environment.

2. The method of claim 1 further comprising:
when the hydrocarbon leak does not exist and when the discrepancy between the hydrocarbon inputs and the hydrocarbon outputs does not exist, generating a non-fungible token verifying that the hydrocarbon leak does not exist.

3. The method of claim 1 further comprising:
when the hydrocarbon leak exists, generating data for rendering a user interface to depict the hydrocarbon leak and equipment associated with the hydrocarbon leak and transferring the data to a user system.

4. The method of claim 1 further comprising:
when the hydrocarbon leak does not exist and when the discrepancy between the hydrocarbon inputs and the hydrocarbon outputs exists, classifying the discrepancy as a sensor malfunction and transferring a notification indicating one or more malfunctioning sensors.

5. The method of claim 4 wherein the notification comprises instructions to calibrate the one or more malfunctioning sensors.

6. The method of claim 4 wherein the notification indicates locations of the one or more malfunctioning sensors.

7. The method of claim 1 wherein:
processing the sensor data using the thermodynamic model to determine when the discrepancy exists between the hydrocarbon inputs and the hydrocarbon outputs comprises determining a volumetric difference between natural gas inputs and natural gas outputs from the hydrocarbon storage environment;
the machine learning output indicates a flowrate for a natural gas leak in the hydrocarbon storage environment; and further comprising:
comparing the flowrate for the natural gas leak to the volumetric difference between the natural gas inputs and the natural gas outputs and confirming a presence of the natural gas leak based on the comparison.

8. A leak identification system to confirm sensor outputs in a hydrocarbon storage environment, the leak identification system comprising:
processing circuitry configured to:
obtain sensor data that characterizes hydrocarbon inputs and hydrocarbon outputs in the hydrocarbon storage environment;
process the sensor data using a thermodynamic model to determine when a discrepancy exists between the hydrocarbon inputs and the hydrocarbon outputs;
generate feature vectors that represent video data that depicts the hydrocarbon storage environment;
provide the feature vectors as input to a machine learning engine trained to detect hydrocarbon leaks in the hydrocarbon storage environment; and
receive a machine learning output that indicates when a hydrocarbon leak exists in the hydrocarbon storage environment.

9. The system of claim 8 wherein:
when the hydrocarbon leak does not exist and when the discrepancy between the hydrocarbon inputs and the hydrocarbon outputs does not exist, the processing circuitry configured to generate a non-fungible token verifying that the hydrocarbon leak does not exist.

10. The system of claim 8 wherein:
when the hydrocarbon leak exists, the processing circuitry configured to generate data for rendering a user interface to depict the hydrocarbon leak and equipment associated with the hydrocarbon leak and transfer the data to a user system.

11. The system of claim 8 wherein:
when the hydrocarbon leak does not exist and when the discrepancy between the hydrocarbon inputs and the hydrocarbon outputs exists, the processing circuitry configured to classify the discrepancy as a sensor malfunction and transfer a notification indicating one or more malfunctioning sensors.

12. The system of claim 11 wherein the notification comprises instructions to calibrate the one or more malfunctioning sensors.

13. The system of claim 11 wherein the notification indicates locations of the one or more malfunctioning sensors.

14. The system of claim 8 wherein:
the processing circuitry is configured to determine a volumetric difference between natural gas inputs and natural gas outputs from the hydrocarbon storage environment;
the machine learning output indicates a flowrate for a natural gas leak in the hydrocarbon storage environment; and
the processing circuitry is configured to compare the flowrate for the natural gas leak to the volumetric difference between the natural gas inputs and the natural gas outputs and confirm a presence of the natural gas leak based on the comparison.

15. A non-transitory computer-readable medium stored thereon instructions to confirm sensor outputs in a hydrocarbon storage environment, that, in response to execution, cause a system comprising a processor to perform operations, the operations comprising:
obtaining sensor data that characterizes hydrocarbon inputs and hydrocarbon outputs in the hydrocarbon storage environment;
processing the sensor data using a thermodynamic model to determine when a discrepancy exists between the hydrocarbon inputs and the hydrocarbon outputs;
generating feature vectors that represent video data that depicts the hydrocarbon storage environment;
providing the feature vectors as input to a machine learning engine trained to detect hydrocarbon leaks in the hydrocarbon storage environment; and
receiving a machine learning output that indicates when a hydrocarbon leak exists in the hydrocarbon storage environment.

16. The non-transitory computer readable medium claim 15 wherein when the hydrocarbon leak does not exist and when the discrepancy between the hydrocarbon inputs and the hydrocarbon outputs does not exist, the operations further comprise:
generating a non-fungible token verifying that the hydrocarbon leak does not exist.

17. The non-transitory computer readable medium claim 15 wherein when the hydrocarbon leak exists, the operations further comprise:
generating data for rendering a user interface to depict the hydrocarbon leak and equipment associated with the hydrocarbon leak and transferring the data to a user system.

18. The non-transitory computer readable medium claim 15 wherein when the hydrocarbon leak does not exist and when the discrepancy between the hydrocarbon inputs and the hydrocarbon outputs exists, the operations further comprise:
classifying the discrepancy as a sensor malfunction and transferring a notification indicating one or more malfunctioning sensors.

19. The non-transitory computer readable medium claim 15 wherein the notification comprises instructions to calibrate the one or more malfunctioning sensors and indicates locations of the one or more malfunctioning sensors.

20. The non-transitory computer readable medium claim 15 wherein:
processing the sensor data using the thermodynamic model to determine when the discrepancy exists between the hydrocarbon inputs and the hydrocarbon outputs comprises determining a volumetric difference between natural gas inputs and natural gas outputs from the hydrocarbon storage environment;
the machine learning output indicates a flowrate for a natural gas leak in the hydrocarbon storage environment; and the operations further comprising:
comparing the flowrate for the natural gas leak to the volumetric difference between the natural gas inputs and the natural gas outputs and confirming a presence of the natural gas leak based on the comparison.
